(19) United States
(12) Patent Application Publication
(10) Pub. No.: US 2006/0064982 A1
(43) Pub. Date: Mar. 30, 2006

(54) Valve for dynamic control of fuel flow rate in gas turbine power plant, power plant and components thereof employing such valve, and method of constructing such valve

(75) Inventor: John Mitten, Manlius, NY (US)

Correspondence Address: BURR & BROWN, PO BOX 7068, SYRACUSE, NY, 13261-7068, US

(73) Assignee: Mitten Manufacturing, Syracuse, NY (US)

(21) Appl. No.: 10/954,970

(22) Filed: Sep. 30, 2004

(51) Int. Cl. F02C 7/232

(52) U.S. Cl. 60/734

(57) ABSTRACT

There is disclosed a valve comprising a valve body, a bonnet, a bellows assembly and a translator assembly. The bellows assembly comprises a bellows and a bellows flange. The bellows flange is positioned between the bonnet and the valve body. The bellows flange defines a bellows flange opening, around which the bellows is attached. The translator assembly extends through the bellows flange opening. The bellows is attached to a periphery of the translator assembly. The invention also provides a power generating system comprising at least one turbine and at least one combustion system which comprises at least one fuel supply, at least one combustion canister, and at least one valve according to the present invention. There is also provided a method of constructing a valve.

### FIELD OF THE INVENTION

The present invention relates to gas turbine power plants and components thereof, in particular, to valves for dynamic control of fuel flow rates in gas turbine power plants, as well as power plants and components thereof which incorporate such valves. The present invention also relates to methods of making such valves.

### BACKGROUND OF THE INVENTION

A variety of gas turbine power plant designs have been employed in the past. In a representative example, fuel, e.g., natural gas, is fed from a fuel supply into a plurality of fuel manifolds, each fuel manifold communicating with a plurality of fuel lines, each of the fuel lines in turn communicating with a respective combustion canister. The combustion canisters are arranged relative to the turbine such that exhaust from burning the fuel drives the turbine, in a manner which is abundantly well known in the art.

In general, for reducing the consumption of fuel and reducing the levels of emissions to the environment, it is desirable to employ the leanest possible mixture of gas and air. Valves have been employed to control the rate of flow of fuel into each of the combustion canisters, e.g., by providing a valve in each fuel line connecting a combustion canister to a fuel manifold. By providing such valves, it has been possible to provide different flow resistances in different fuel lines, e.g., to make it possible to adjust the fuel in each of the combustion canisters, e.g., such that fuel flow to each combustion canister (and therefore the temperature within each canister) may be maintained at values which are the same as or substantially the same as those in the other combustion canisters. For example, even in cases where different fuel lines are connected to a fuel manifold at locations which are different distances from a fuel inlet connecting the fuel supply to the fuel manifold and/or through flow paths of differing geometries, uniform fuel/air mixtures can be provided to each of the combustion canisters by adjusting the respective valves (for example, by creating greater valve flow resistance in fuel lines which are closer to the fuel inlet, which are affected less by gravity and/or which are connected through a flow path geometry having lower resistance).

One valve design which has been used in such a gas turbine power plant system is depicted in FIG. 1. Referring to FIG. 1, the valve includes a valve body and a bonnet, the valve body including a valve stem and a translator. The valve body includes a bonnet receiving region in which at least a portion of the bonnet is positioned, and a flow channel 100.

The valve is connected in a well known manner to a flanged inlet pipe (not shown) on one side of the valve and a flanged outlet pipe (not shown) on the other side of the pipe by connecting a first circumferential flange 101 on the valve body to a circumferentially flanged inlet pipe such that a conduit defined by the inlet pipe communicates with the flow channel 100, and connecting a second circumferential flange 102 on the valve body to a circumferentially flanged outlet pipe such that a conduit defined by the outlet pipe also communicates with the flow channel 100. Accordingly, the conduit defined by the inlet pipe communicates with the conduit defined by the outlet pipe through the flow channel 100 which passes through the valve.

The valve stem includes a cranking portion 110, a cylindrical portion 111 and a bell-shaped portion 112. The translator includes a translator stem portion 113 and a flow regulating portion 114. The translator stem portion 113 has external threads which engage internal threads on a threaded insert 115 which is welded to the inside of the bell-shaped portion 112.

The cranking portion 110 of the valve stem can readily be engaged with a manual cranking tool in order to rotate the valve stem about its axis (i.e., the valve stem rotates axially without moving translationally), thereby causing the translator to move in a direction along the axis of the valve stem by virtue of the threading of the external threads of the translator stem portion 113 on the internal threads of the threaded insert 115. As a result of such motion, the flow regulating portion 114 of the translator moves relative to the flow channel 100 between a position (see FIG. 2) where the flow regulating portion 114 is in contact with the bottom (in the orientation shown in FIG. 2) surface of the flow channel 100, i.e., the surface which is opposite to the valve stem (maximum flow obstruction) and a position where the flow regulating portion 114 is retracted (upward in the orientation shown in FIG. 2) out of the flow channel 100 (minimum flow obstruction).

Such a valve stem is referred to herein as a “non-rising” valve stem, because operation of the valve can be achieved without the valve stem rising or falling within the valve body (rising or falling referring to moving upward or downward in the perspective depicted in FIG. 1). That is, the valve can be operated by rotating the valve stem about its axis without moving the valve stem translationally.

Such a valve has been effective as a flow control valve in which the position of the translator can be set by rotation of the valve stem to provide a desired flow resistance, and the translator remains in that position for the duration of the useful life of the valve. As such, a plurality of such valves can be manufactured, and then each of the valves can be set at a different flow resistance to provide the varying flow resistances required of a set of valves in the fuel lines extending from different positions along a fuel manifold. Such valves are sometimes referred to as “set and forget” valves.

Despite such valves and the myriad systems in practice, there is an ongoing need for systems which generate power more efficiently, more safely and with fewer environmental side effects (e.g., reduced leakage).

### SUMMARY OF THE INVENTION

In order to provide systems which generate power more efficiently, more safely and with fewer environmental side effects, in accordance with the present invention, there is provided an improved valve for dynamically controlling fuel flow into each of the combustion canisters, in order to be able to intermittently or substantially continuously tune the system (e.g., a gas turbine power plant). For example, the valves can be dynamically controlled based on any desired feedback controls, e.g., measuring specific operating parameters, comparing such measurements with desired values or other measured values and making appropriate adjustments to the fuel flow rates by adjusting the respective positions of the flow modulating regions of one or more valves. Providing the ability to dynamically control fuel flow into each combustion canister separately makes it possible to balance fuel flow to each combustion canister and/or to tune one or more aspect of the system, for example, to control one or more parameters (e.g., temperature) within the system (e.g., to make it uniform or to make it follow a desired profile), and/or to eliminate one or more dynamic phenomena (e.g., vibration within the system). Such dynamic control of fuel flow into each combustion canister makes it possible to re-tune the system as necessary, e.g., when operating conditions change over time.

An ongoing challenge with regard to such valves is minimizing leakage out of the valves. The present invention provides a valve with very low leakage or no leakage which can be employed in a gas turbine power plant and which can be dynamically controlled.

In addition, it would be desirable to provide such a valve which requires less force to adjust the flow characteristics of the valve. The present invention provides a valve which can be employed in a gas turbine power plant and which requires less force to adjust the flow characteristics in dynamically controlling the valve.

Another ongoing objective is to provide such a valve which includes fewer parts. The present invention provides a valve having very few parts, which can be employed in a gas turbine power plant and which can be dynamically controlled.

In addition, providing dynamic control valves for use in providing long-term control, especially substantially continuous control, raises a spectrum of engineering concerns in comparison with “set and forget” valves.

For example, in a valve as shown in FIG. 1, movement of a valve stem to dynamically adjust the valve generates heat due to the friction between the valve stem and the seal (e.g., packing). The tighter the seal, and the greater the frequency of movement of the valve stem, the more heat is generated, such heat (particularly over extended periods of time) having a tendency to reduce the useful life of the valve.

There is further a desire to minimize vibration of the valve stem within the valve body, regardless of the exact instantaneous position of the valve stem within the valve, and a desire to avoid the need to adjust tightness of a seal between the valve stem and the valve body.

In accordance with a first aspect of the present invention, there is provided a valve comprising:

a valve body, the valve body comprising a flow channel defining region which defines a flow channel;

a bonnet;

a bellows assembly comprising a bellows and a bellows flange, the bellows flange being positioned between the bonnet and the valve body, the bellows flange defining a bellows flange opening, the bellows being attached to the bellows flange around the bellows flange opening; and

a translator assembly comprising a translator main shaft, a translator stub shaft and a translator, the translator assembly extending through the bellows flange opening, the bellows being attached to the translator stub shaft around a periphery of the translator stub shaft to provide a seal between the bellows flange and the translator stub shaft, the translator main shaft being threaded with the translator stub shaft, whereby rotation of the translator main shaft about an axis of the translator main shaft causes the translator to move between a first translator position and a second translator position, the translator blocking at least a portion of the flow channel when the translator is in the second translator position.

By providing such a valve, movement of the valve can be accomplished with very little force acting on the translator main shaft, in comparison with valves which include packing to provide a seal. For example, by comparison, the packing around the valve stem of the valve depicted in FIG. 1 makes it necessary to exert a substantially greater torque on the cranking portion 110 of the valve stem to raise or lower the flow regulating portion 114 of the translator. With the valve of the present invention, the only forces resisting movement of the valve are the spring force of the bellows and the friction between the translator stub shaft threads and the translator main shaft threads.

Another advantage of the present invention is that such a valve includes a relatively low number of parts which must be manufactured and assembled.

A further advantage of the present invention is that the valve according to the present invention can provide a long mean time to repair (i.e., the valve does not break down frequently).

In addition, by providing such a valve, potential leak paths from the valve are reduced in comparison with, e.g., the valve depicted in FIG. 1, in which leakage can occur through various paths, e.g., between the valve stem 111 and the packing, between the packing and the bonnet, or between the bonnet and the valve body. Furthermore, the tightness between the bellows flange and the valve body can be very high without affecting the force needed to move the valve-accordingly, the pressure between the bellows flange and the valve body can be made very high in order to limit or prevent leakage, without compromising ease of valve operation.

Yet another advantage of the present invention is that the distance between the inlet to the flow channel and the outlet from the flow channel can be very small, i.e., the size from inlet to outlet of the valve according to the present invention can be very small.

Preferably, the valve further comprises at least one bearing plate which defines a bearing plate opening through which the translator assembly extends, the bearing plate being positioned between and in contact with the bellows flange and the bonnet.

Preferably, the valve further comprises a first bearing means and a second bearing means, the first bearing means being in contact with a first surface of the bonnet, the second bearing means being in contact with a second surface of the bonnet, the first bearing means being spaced from the second bearing means in a direction parallel to the axis of the translator main shaft, the translator main shaft having a first shoulder portion and a second shoulder portion, the first shoulder portion abutting the first bearing means, the second shoulder portion abutting the second bearing means, whereby the translator main shaft is substantially prevented from moving along its axis relative to the bonnet or the valve body, while being able to rotate freely about its axis.

Preferably, the valve further comprises at least one gasket positioned between and in contact with the bellows flange and the valve body, the gasket defining a gasket opening through which the translator assembly extends.

Preferably, the translator assembly further comprises a stub shaft collar which abuts the translator main shaft when the translator is in the first translator position.

Preferably, the valve further comprises a translator guide attached to the valve body.

In accordance with a second aspect of the present invention, there is provided a power generating system, comprising:
at least one turbine; and at least one combustion system, the combustion system comprising:
at least one fuel supply;
   at least one combustion canister;
   at least one valve as described above; and
   at least one fuel conduit communicating between the fuel supply and the combustion canister through the flow channel.

In accordance with a third aspect of the present invention, there is provided a method of constructing a valve, comprising:

positioning a first bearing means in contact with a first surface of a bonnet;

positioning a translator main shaft in contact with the first bearing means, the translator main shaft having a first shoulder and a second shoulder, the contact between the first bearing means and the translator main shaft being on the first shoulder;

positioning a second bearing means in contact with the second shoulder;

positioning a bearing plate in contact with the second bearing means, the bearing plate defining a bearing plate opening through which the translator main shaft extends;

positioning a bellows assembly in contact with the bearing plate, the bellows assembly comprising a bellows and a bellows flange, the bellows flange defining a bellows flange opening, the bellows being attached to the bellows flange around the bellows flange opening, the contact between the bearing plate and the bellows assembly being on the bellows flange;

threading a translator stub shaft with the translator main shaft, the translator stub shaft having a translator attached thereto;

attaching the bellows to the translator stub shaft;

positioning the translator in a translator guide attached to a valve body; and

attaching the bonnet to the valve body.

Preferably, the method further comprises positioning a gasket in contact with the bellows flange before threading the translator stub shaft with the translator main shaft, the gasket defining a gasket opening through which the translator assembly extends.

The present invention may be more fully understood with reference to the accompanying drawings and the following detailed description of the invention.

### BRIEF DESCRIPTION OF THE DRAWING FIGURES

FIG. 1 is a sectional view of a valve which has been used in gas turbine power plant systems.

FIG. 2 is a front view of the valve depicted in FIG. 1.

FIG. 3 is a sectional view of an example of a preferred embodiment of a valve according to the present invention.

FIG. 4 is a front view of the valve depicted in FIG. 3.

FIG. 5 is a cross-sectional view along the line 5-5 in FIG. 3.

FIG. 6 is a perspective view of the valve depicted in FIGS. 3-5.

FIG. 7 depicts connection of the valve depicted in FIGS. 3-6 within a flow path between a first flanged pipe and a second flanged pipe.

FIG. 8 shows a guide 60 of the valve depicted in FIGS. 3-6 separate from the valve.

FIG. 9 is a schematic view of a power generating system.

FIG. 10 is a schematic sectional view along line 10-10 in FIG. 9.

FIG. 11 is a sectional view of the bellows assembly 12, the stub shaft collar 43 and the translator 42 of the valve depicted in FIGS. 3-6 separate from the valve.

FIG. 12 is a sectional view of the stub shaft 41, the stub shaft collar 43 and the translator 42 of the valve depicted in FIGS. 3-6 separate from the valve.

FIG. 13 is a sectional view along line 13-13 in FIG. 12.

FIG. 14 is a perspective view of the translator main shaft 40 of the valve depicted in FIGS. 3-6 separate from the valve.

FIG. 15 is a sectional view of the bonnet 11 of the valve depicted in FIGS. 3-6 separate from the valve.

FIG. 16 is a sectional view (not to scale) of a bearing plate in accordance with the present invention.

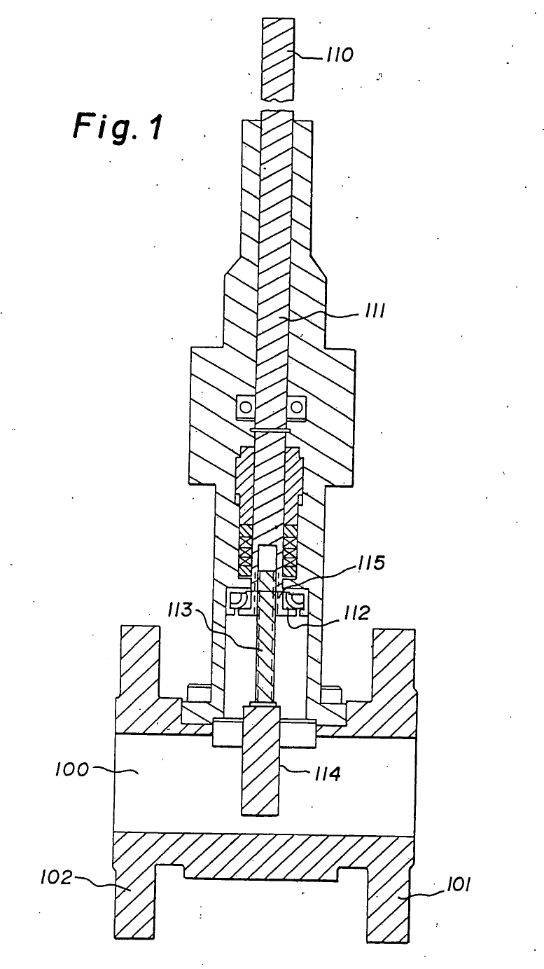

### DETAILED DESCRIPTION OF THE INVENTION

As described above, in accordance with a first aspect of the present invention, there is provided a valve comprising a valve body, a bonnet, a bellows assembly and a translator assembly.

As described above, the valve body comprises a flow channel defining region which defines a flow channel. The valve body can be generally of any shape which includes at least one flow channel through which fluid passing through the valve can flow. Fluid passing through the valve passes through the flow channel from a flow channel inlet on the valve body to a flow channel outlet on the valve body. Preferably, the valve body includes a flow channel defining portion and a valve housing portion, the valve housing portion defining a chamber in which at least part of the translator assembly is housed.

The valve body can be made of any suitable material or materials, such material(s) preferably being substantially impervious to and resistant to (e.g., avoiding corrosion or chemical attack) any fluids with which the valve would be expected to come into contact in use, for example, fluids such as air and rain water which might come into contact with the exterior of the valve, as well as fuel and/or fuel-air mixtures which might be supplied to the flow channel inlet for passage through the valve. In addition, the material of the valve body must be capable of withstanding the conditions to which it will be subjected during use, e.g., high temperatures and pressures, vibration, and any other forces that may impact the valve body. For example, suitable materials out of which the valve body can be constructed include metals. A preferred example of a suitable group of materials out of which the valve body can be constructed is stainless steel materials.

As used herein, the expression “values which are the same as or substantially the same as” means that the respective values are within 10% of each other; the expression “substantially prevented from moving along its axis” means capable of moving not more than 5% of its length; the expression “substantially annular” means at least about 90% of the volume of the shape lies within an annular space which is at least about 90% filled by the shape; the expression “substantially prevented from rotating” means capable of rotating not more than 10 degrees about its axis; the expression “substantially at its free length” means a length which is within about 10% of its free length; and the expression “coefficient of thermal expansion which is substantially similar” means that the respective values are within about 10% of each other.

As described above, the bellows assembly comprises a bellows and a bellows flange, the bellows flange being positioned between the bonnet and the valve body, the bellows flange defining a bellows flange opening, the bellows being attached to the bellows flange around the bellows flange opening.

Preferably, the bellows flange is of a substantially annular shape, although the bellows flange can in general be any shape which defines a bellows flange opening and to which the bellows can be attached around the bellows flange opening.

The bellows flange can be made of any suitable material or materials, such material(s) preferably being substantially impervious to and resistant to (e.g., avoiding corrosion or chemical attack) any fluids with which the bellows flange would be expected to come into contact in use, for example, fluids such as air and rain water (from the outside), as well as fuel and/or fuel-air mixtures (from the inside). In addition, the material of the bellows flange must be capable of withstanding the conditions to which it will be subjected during use, e.g., high temperatures and pressures, vibration, and any other forces that may impact the bellows flange.

For example, suitable materials out of which the bellows flange can be constructed include metals. A preferred example of a suitable group of materials out of which the bellows flange can be constructed is stainless steel materials.

Preferably, the bellows is attached to the bellows flange by being welded thereto. The bellows can be generally of any shape which can readily accommodate relative motion between the bellows flange and the translator stub shaft (the bellows being attached to both of these). The bellows can be made of any suitable material or materials, such material(s) preferably being substantially impervious to and resistant to (e.g., avoiding corrosion or chemical attack) any fluids with which the bellows would be expected to come into contact in use, for example, fuel and/or fuel-air mixtures. In addition, the material of the bellows must be capable of withstanding the conditions to which it will be subjected during use, e.g., high temperatures and pressures, vibration, and any other forces that may impact the bellows. For example, suitable materials out of which the bellows can be constructed include metals. A preferred example of a suitable group of materials out of which the bellows can be constructed is stainless steel materials. Preferably, the bellows is a multi-ply structure (e.g., including three plies), preferably made of stainless steel. A specific example of a preferred bellows comprises three plies made of stainless steel 321, each being 5 thousandths (i.e., 5/1000 of an inch) thick. With such a multi-ply bellows, in the event that one of the plies fails, one or more other plies remain intact to hold the seal.

As described above, the translator assembly comprises a translator main shaft, a translator stub shaft and a translator.

The translator main shaft can be generally of any shape, so long as it performs the functions of the translator main shaft as described above. The translator main shaft can be made of any suitable material or materials, such material(s) preferably being substantially impervious to and resistant to (e.g., avoiding corrosion or chemical attack) any fluids with which the translator main shaft would be expected to come into contact in use, for example, fluids such as air and rain water. In addition, the material of the translator main shaft must be capable of withstanding the conditions to which it will be subjected during use, e.g., high temperatures and pressures, vibration, and any other forces that may impact the translator main shaft.

For example, suitable materials out of which the translator main shaft can be constructed include metals. A preferred example of a suitable group of materials out of which the translator main shaft can be constructed is stainless steel materials.

The translator main shaft is a “non-rising” translator main shaft. Preferably, the translator main shaft is substantially prevented from moving relative to the valve body, except for rotation about the axis of the translator main shaft.

The translator main shaft preferably comprises a cranking portion which extends outside of the bonnet and which preferably has an axis which is co-linear with the translator main shaft axis. The cranking portion of the translator main shaft preferably has a square or a hexagonal cross-section, which can readily be engaged, e.g., by a tool or mechanical gear box in order to cause rotation of the translator main shaft about its axis. Alternatively, the cranking portion may include any other suitable shape, e.g., a knob, a handwheel, a spline, round with a key, etc.

The translator main shaft has a translator main shaft threaded region on which translator main shaft threads are provided. Such translator main shaft threads can be provided on an internal surface (i.e., female threads) or on an external surface (i.e., male threads).

The translator stub shaft has a translator stub shaft threaded region on which translator stub shaft threads are provided. Such translator stub shaft threads are threaded with the translator main shaft threads (as used herein, an expression that a first component is “threaded with” a second component means that the first component is the male component or the female component). Where the translator main shaft threads are provided internally on the translator main shaft (i.e., female threading), the translator stub shaft threads are provided externally on the translator stub shaft (i.e., male threading); where the translator main shaft threads are provided externally on the translator main shaft (i.e., male threading), the translator stub shaft threads are provided internally on the translator stub shaft (i.e., female threading). It is another advantage of the present invention that the threaded engagement between the translator main shaft and the translator stub shaft is not in the path of fluid (e.g., fuel) passing through the valve. Accordingly, one or more anti-galling compounds (e.g., high temperature anti-galling compounds), such as Loctite® Heavy Duty Anti-Seize #51605 can be applied between the translator stub shaft threads and the translator main shaft threads.

The translator stub shaft can be generally of any shape, so long as it performs the functions of the translator stub shaft as described above. The translator stub shaft can be made of any suitable material or materials, such material(s) preferably being substantially impervious to and resistant to (e.g., avoiding corrosion or chemical attack) any fluids with which the translator main shaft would be expected to come into contact in use, for example, fluids such as fuel and/or fuel-air mixtures. In addition, the material of the translator stub shaft must be capable of withstanding the conditions to which it will be subjected during use, e.g., high temperatures and pressures, vibration, and any other forces that may impact the translator stub shaft.

For example, suitable materials out of which the translator stub shaft can be constructed include metals. A preferred example of a suitable group of materials out of which the translator stub shaft can be constructed is stainless steel materials.

The translator is attached to (e.g., screw threaded to, or integral with) the translator stub shaft.

The translator can be generally of any shape, so long as it performs the functions of the translator as described above. The translator can be made of any suitable material or materials, such material(s) preferably being substantially impervious to and resistant to (e.g., avoiding corrosion or chemical attack) any fluids with which the translator would be expected to come into contact in use, for example, fluids such as fuel and/or fuel-air mixtures. In addition, the material of the translator must be capable of withstanding the conditions to which it will be subjected during use, e.g., high temperatures and pressures, vibration, and any other forces that may impact the translator.

For example, suitable materials out of which the translator can be constructed include metals. A preferred example of a suitable group of materials out of which the translator can be constructed is stainless steel materials.

The translator stub shaft is prevented from freely rotating about its axis by any suitable structure. Preferably, the translator stub shaft is substantially prevented from rotating about its axis to any degree.

For example, a suitable structure for substantially preventing the translator stub shaft from rotating is a translator guide which defines a guide opening which surrounds a guide engaging portion of the translator. Such a guide opening preferably has a non-cylindrical shape, and the guide engaging portion of the translator preferably also has a non-cylindrical shape (which preferably corresponds with the non-cylindrical shape of the guide opening).

A translator guide, when employed, can be generally of any shape, so long as it provides a guide opening as described above. Preferably, such a translator guide is attached to the valve body. A translator guide can be made of any suitable material or materials, such material(s) preferably being substantially impervious to and resistant to (e.g., avoiding corrosion or chemical attack) any fluids with which the translator guide would be expected to come into contact in use, for example, fluids such as fuel and/or fuel-air mixtures. In addition, the material of the translator guide must be capable of withstanding the conditions to which it will be subjected during use, e.g., high temperatures and pressures, vibration, and any other forces that may impact the translator guide. For example, suitable materials out of which a translator guide can be constructed include metals. A preferred example of a suitable group of materials out of which a translator guide can be constructed is bronze materials.

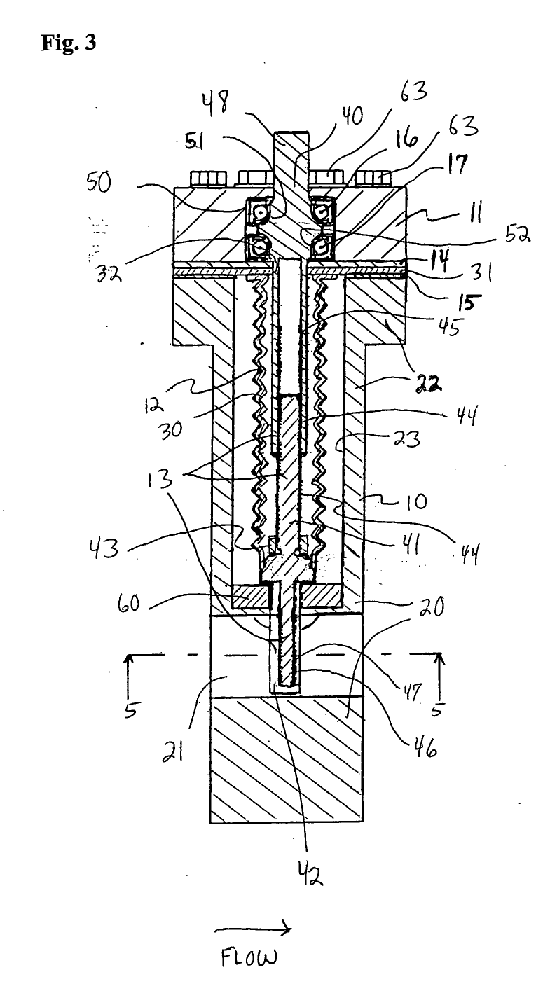

Accordingly, and from the perspective shown in an embodiment as depicted in FIG. 3, when the translator main shaft is rotated about its axis in a first direction (i.e., looking down from the perspective shown in FIG. 3, clockwise or counter-clockwise), by virtue of the threading of the translator main shaft threads on the translator stub shaft threads, the translator stub shaft and the translator move upward, and when the translator main shaft is rotated about its axis in the opposite direction, the translator stub shaft and the translator are moved downward. When the translator is in its lowermost (from the perspective shown in FIG. 3) position, a portion of the translator is positioned in the flow path of fluid passing through the flow channel from the flow channel inlet to the flow channel outlet, such that the flow of such fluid is impeded to some extent, whereby the flow rate of said fluid through the flow channel is decreased by virtue of the impedance created by the portion of the translator in the flow path of the fluid traveling through the flow channel. Preferably, the respective components are dimensioned such that with the translator halfway between its fully extended and fully retracted positions (i.e., with its remote end halfway between opposite sides of the flow channel), the bellows is substantially at its free length (i.e., in the perspective shown in FIG. 3, the lower end of the bellows is hanging to the same extent it would be hanging if it were not attached to anything—that is, the distance between the bellows flange and the portion of the bellows which is attached to the translator stub shaft is the same as if the bellows assembly were in the same orientation with the bellows flange held and the bellows hanging freely).

Preferably, the translator stub shaft threads have a coefficient of thermal expansion which is substantially similar to a coefficient of thermal expansion of the translator main shaft threads. By providing such a thermal expansion match (or substantial match), the relative positioning of the various surfaces of the translator main shaft threads with respect to the surfaces of the translator stub shaft threads is more closely maintained during changes in conditions (e.g., a power plant operating at full capacity versus a power plant which is temporarily shut down), whereby the respective threaded surfaces can be readily moved relative to one another over a wide range of conditions. By providing such thermal expansion matching (or substantial matching), the tendency of the translator stub shaft threads and the translator main shaft threads to seize is reduced.

More preferably, the translator threads and the valve stem threads are formed of the same material. Even more preferably, the entire translator stub shaft and the entire translator main shaft are both formed of the same material.

Preferably, an anti-galling material is applied to the respective threads in order to further reduce the possibility of seizing. For example, a suitable anti-galling material is marketed by Loctite® under the name “HD Anti-seize (51605).”

As discussed above, another important aspect of the present invention is the provision of a valve which does not exhibit significant vibration even when it is deployed in a system which experiences large forces, e.g., the combustion dynamics in a cannular gas turbine combustor power plant system. A further important aspect of the present invention is the provision of a valve which does not exhibit significant vibration even when a system in which it is deployed is shut down and re-started, and even in the event that such cycling occurs repeatedly. For example, a need frequently arises to shut down a gas turbine power plant. According to this aspect of the present invention, there is provided a valve which exhibits such resistance to vibration and in which the degree of resistance to flow through the flow channel can readily be manually or automatically modified regularly or, if necessary, substantially continuously.

As stated above, preferably, the translator main shaft has a first shoulder portion and a second shoulder portion, such shoulder portions being attached to (e.g., integral with, threaded on or welded to) the translator main shaft, a first bearing means is positioned between the bonnet and the first shoulder, and a second bearing means is positioned between the bearing plate and the second shoulder. The shoulder portions and the bearing means can be any shape or orientation which substantially prevents the translator main shaft from moving axially while being free to rotate about its axis, or the shoulder portions and/or the bearing means, or components thereof, can be substituted for with any other structure or structures which substantially prevent the translator main shaft from moving axially while being free to rotate about its axis. The shoulder portions can be made of any suitable material or materials, such material(s) preferably being substantially impervious to and resistant to (e.g., avoiding corrosion or chemical attack) any fluids with which the shoulder portions would be expected to come into contact in use, for example, fluids such as air and rain water. In addition, the material of the shoulder portions must be capable of withstanding the conditions to which they will be subjected during use, e.g., high temperatures and pressures, vibration, and any other forces that may impact the shoulder portions.

For example, suitable materials out of which the shoulder portions can be constructed include metals. A preferred example of a suitable group of materials out of which the shoulder portions can be constructed is stainless steel materials.

Bearing means which are suitable for use in accordance with the present invention include any type of bearings for permitting rotational movement as described above, a wide variety of such bearings being well known to those of skill in the art. For example, a well-known bearing means which is suitable for use in accordance with the present invention comprises a casing which defines an annular space, in which a plurality of spherical articles are positioned.

As described above, the bellows is attached to the translator stub shaft around a periphery of the translator stub shaft to provide a seal between the bellows flange and the translator stub shaft. Preferably, such attachment is accomplished by welding the bellows to the translator stub shaft.

Preferably, the translator assembly further comprises a stub shaft collar which abuts the translator main shaft when the translator is in the first translator position.

Where the translator assembly further comprises a stub shaft collar, the stub shaft collar is attached to the translator assembly, e.g., it is welded to or threaded onto the translator stub shaft. The stub shaft collar can be generally of any suitable shape, and preferably also functions as a stop to prevent the translator stub shaft and the translator main shaft from coming into contact with each other and sticking to one another at a location other than their respective threads (for example, in the embodiment shown in FIG. 3, preventing the top end of the translator stub shaft from coming into contact with the top of the cavity within the translator main shaft in which the translator stub shaft moves up and down, if the valve is dimensioned such that the translator stub shaft could otherwise come into contact with the top of the cavity within the translator main shaft—preferably, the valve is dimensioned such that such contact is not possible).

The stub shaft collar can be made of any suitable material or materials, such material(s) preferably being substantially impervious to and resistant to (e.g., avoiding corrosion or chemical attack) any fluids with which the stub shaft collar would be expected to come into contact in use, for example, fluids such as fuel and/or fuel-air mixtures. In addition, the material of the stub shaft collar must be capable of withstanding the conditions to which it will be subjected during use, e.g., high temperatures and pressures, vibration, and any other forces that may impact the stub shaft collar.

For example, suitable materials out of which the stub shaft collar can be constructed include metals. A preferred example of a suitable material out of which the stub shaft collar can be constructed is bronze, which helps to avoid the possibility of galling.

As described above, preferably, the valve further comprises at least one bearing plate which defines a bearing plate opening through which the translator assembly extends, the bearing plate being positioned between and in contact with the bellows flange and the bonnet. Such a bearing plate provides a surface against which the second bearings abut. The bearing plate, when included, can be generally of any suitable shape, e.g., an annular shape. Preferably, the bearing plate has a surface which slopes toward the bearing plate opening (see FIG. 16). The sloped surface assists in withstanding thrust applied against the bearing plate. The bearing plate can be made of any suitable material or materials, such material(s) preferably being substantially impervious to and resistant to (e.g., avoiding corrosion or chemical attack) any fluids with which the bearing plate would be expected to come into contact in use. In addition, the material of the bearing plate must be capable of withstanding the conditions to which it will be subjected during use, e.g., high temperatures and pressures, vibration, and any other forces that may impact the bearing plate. For example, suitable materials out of which the bearing plate can be constructed include metals. A preferred example of a suitable group of materials out of which the bearing plate can be constructed is stainless steel materials.

As described above, preferably, the valve further comprises at least one gasket positioned between and in contact with the bellows flange and the valve body, the gasket defining a gasket opening through which the translator assembly extends. Such a gasket can be used to enhance the seal between the valve body and the bellows flange. The gasket, when included, can be generally of any suitable shape, e.g., an annular shape. The gasket can be made of any suitable material or materials, such material(s) preferably being substantially impervious to and resistant to (e.g., avoiding corrosion or chemical attack) any fluids with which the bearing plate would be expected to come into contact in use. In addition, the material of the gasket must be capable of withstanding the conditions to which it will be subjected during use, e.g., high temperatures and pressures, vibration, and any other forces that may impact the bearing plate. A wide variety of such gaskets are well known to those of skill in the art.

The bonnet is attached to the valve body with the bellows flange (and optionally a bearing plate and/or a gasket) sandwiched therebetween. For example, the bonnet can be attached to the valve body by bolts which pass through holes formed in the bonnet and the bellows flange (and, if present, the bearing plate and/or the gasket) and into tap holes formed in the valve body. By virtue of the present invention, the connection between the bonnet and the valve body can be tightened as much as desired, thereby enhancing the seal therebetween, without affecting the torque required to operate the valve (i.e., to rotate the translator main shaft to move the translator relative to the flow channel).

In addition, most of the components of the valve according to the present invention can be employed in valves of a variety of flow channel diameters, i.e., it is possible for the only components which differ between valves of different flow channel diameters to be the valve body, the translator and the translator guide.

As described above, in accordance with a second aspect, the present invention is directed to a power generating system which comprises at least one turbine, and at least one combustion system comprising at least one fuel supply, at least one combustion canister, at least one valve as described herein, and at least one fuel conduit communicating between the fuel supply and the combustion canister through the flow channel in the valve. Turbines, fuel supplies and combustion canisters, as well as the connection of each of those elements and the relative orientation of those elements in a wide variety of arrangements are well known to those of skill in the art, and the present invention encompasses all such arrangement in general.

In a representative system, a main fuel line feeds fuel to respective inlets for primary, secondary and tertiary fuel lines within a skid. The primary, secondary and tertiary fuel lines supply fuel to a primary fuel manifold, a secondary fuel manifold and a tertiary fuel manifold, respectively. Each fuel manifold supplies fuel through a plurality of fuel lines, e.g., fourteen fuel lines per fuel manifold, and each fuel line communicates on an opposite end with a combustion canister (e.g., fourteen combustion canisters per manifold).

For each fuel manifold, the respective fuel lines are connected at different locations. Accordingly, the flow from the fuel supply to each of the respective combustion chambers is not identical, and therefore valves are provided in each of the fuel lines in order to modulate the flow of fuel in each of the respective fuel lines, making it possible to tune the overall system.

As described above, in accordance with a third aspect of the present invention, there is provided a method of constructing a valve, comprising:

positioning a first bearing means in contact with a first surface of a bonnet;

positioning a translator main shaft in contact with the first bearing means, the translator main shaft having a first shoulder and a second shoulder, the contact between the first bearing means and the translator main shaft being on the first shoulder; positioning a second bearing means in contact with the second shoulder;

positioning a bearing plate in contact with the second bearing means, the bearing plate defining a bearing plate opening through which the translator main shaft extends;

positioning a bellows assembly in contact with the bearing plate, the bellows assembly comprising a bellows and a bellows flange, the bellows flange defining a bellows flange opening, the bellows being attached to the bellows flange around the bellows flange opening, the contact between the bearing plate and the bellows assembly being on the bellows flange;

threading a translator stub shaft with the translator main shaft, the translator stub shaft having a translator attached thereto;

attaching the bellows to the translator stub shaft;

positioning the translator in the translator guide which is attached to a valve body; and

attaching the bonnet to the valve body.

Preferably, the method is performed sequentially as listed above.

Preferably, the method further comprises positioning a gasket in contact with the bellows flange before threading the translator stub shaft with the translator main shaft, the gasket defining a gasket opening through which the translator assembly extends.

FIG. 3 depicts an example of a preferred embodiment of a valve according to the present invention. The valve includes a valve body 10, a bonnet 11, a bellows assembly 12, a translator assembly 13, an annular bearing plate 14, an annular gasket 15 and first and second bearing means 16 and 17.

In this embodiment, the valve body 10 is made of stainless steel 303 and includes a first portion 20 which defines a flow channel 21 and a second portion 22 which defines a chamber 23.

The bellows assembly 12 is made of stainless steel 316 and comprises a bellows 30 and an annular bellows flange 31, the bellows flange 31 being positioned between the bonnet 11 and the valve body 10. The bellows flange 31 defines a bellows flange opening 32. The bellows 30 is welded to the bellows flange 31 around the bellows flange opening 32. The bellows 30 includes on the end remote from the bellows flange 31 a tube which is welded to the translator stub shaft 41.

The translator assembly 13 comprises a translator main shaft 40 formed of stainless steel 316, a translator stub shaft 41 formed of stainless steel 316 and a translator 42 formed of stainless steel 316. The translator assembly 13 extends through an opening in the gasket 15, the bellows flange opening 32 and an opening in the bearing plate 14. A stub shaft collar 43 formed of bronze is threaded onto threads 44 on the translator stub shaft 41, and the stub shaft collar 43 is held in place with set screws (not shown) which extend through the stub shaft collar 43 and which abut the translator stub shaft 41. The translator main shaft 40 has internal threads 45 which are threaded on the threads 44 of the translator stub shaft 41, whereby rotation of the translator main shaft 40 about its axis causes the translator 42 to move (along the translator main shaft axis) between a first translator position and a second translator position, the translator 42 blocking at least a portion of the flow channel 21 when the translator is in the second translator position. The translator cannot be moved into a position where it completely blocks the flow channel 21 (for safety reasons, when the valve is used in a power generating system as described herein, at least some fuel or fuel/air mixture needs to always be able to pass through the valve). The translator 42 has internal threads 46 which are threaded onto external threads 47 of the translator stub shaft 41, and the translator 42 is held in place by drilling a hole through the translator 42 and into the translator stub shaft 41, inserting a dowel pin (not shown) into the hole, and plug welding the dowel pin. The translator main shaft 40 has a cranking portion 48 which extends outside of the bonnet 11 and has an axis which is co-linear with the axis of the translator main shaft 40. The cranking portion 48 has a square cross-section.

The first bearing means 16 is positioned between a surface 50 of the bonnet 11 and a first shoulder portion 51 of the translator main shaft 40. The second bearing means 17 is positioned between the bearing plate 14 and a second shoulder portion 52 of the translator main shaft 40.

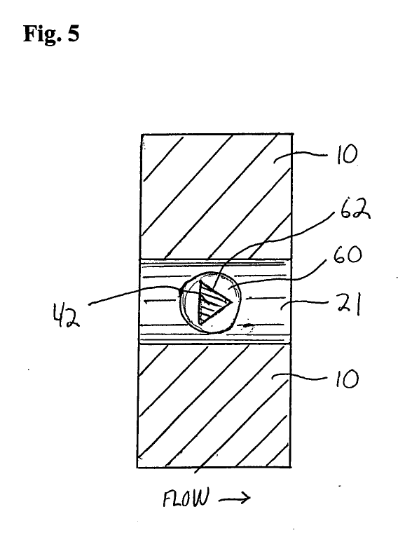

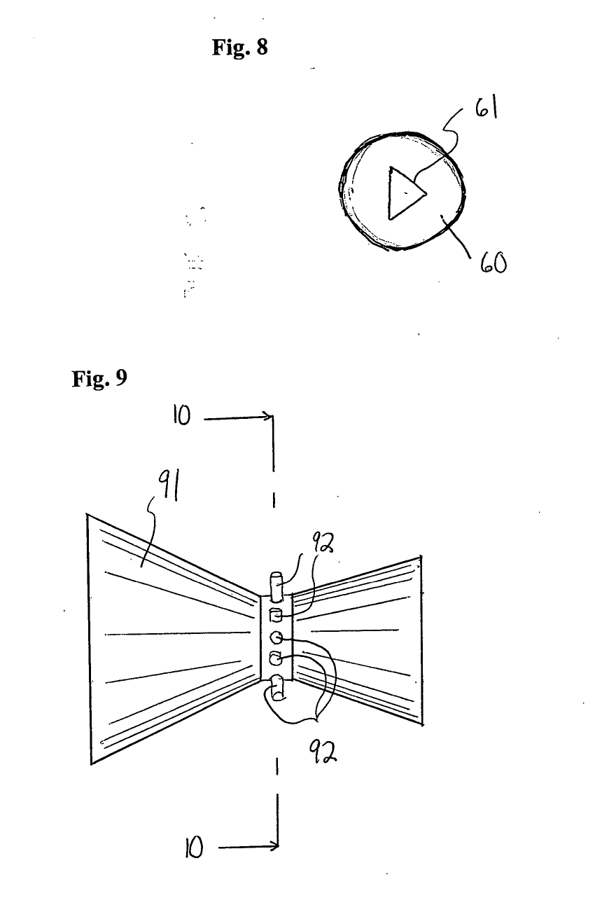

A translator guide 60 is attached to the valve body 10 by one or more bolts (not shown). The translator guide 60 defines a translator guide opening 61 (see FIG. 8) which surrounds a guide-engaging portion 62 (see FIG. 5) of the translator 42. The translator guide opening 61 has a non-cylindrical shape, namely triangular, and the guide-engaging portion 62 of the translator 42 also has a non-cylindrical shape which corresponds with the non-cylindrical shape of the guide opening 61, i.e., also triangular and slightly larger.

The bonnet 11 is attached to the valve body 10 (with the bearing plate 14, the bellows flange 31 and the gasket 15 sandwiched therebetween) by bolts 63 which pass through holes formed in the bonnet 11, the bearing plate 14, the bellows flange 31 and the gasket 15 and into tap holes formed in the valve body 10.

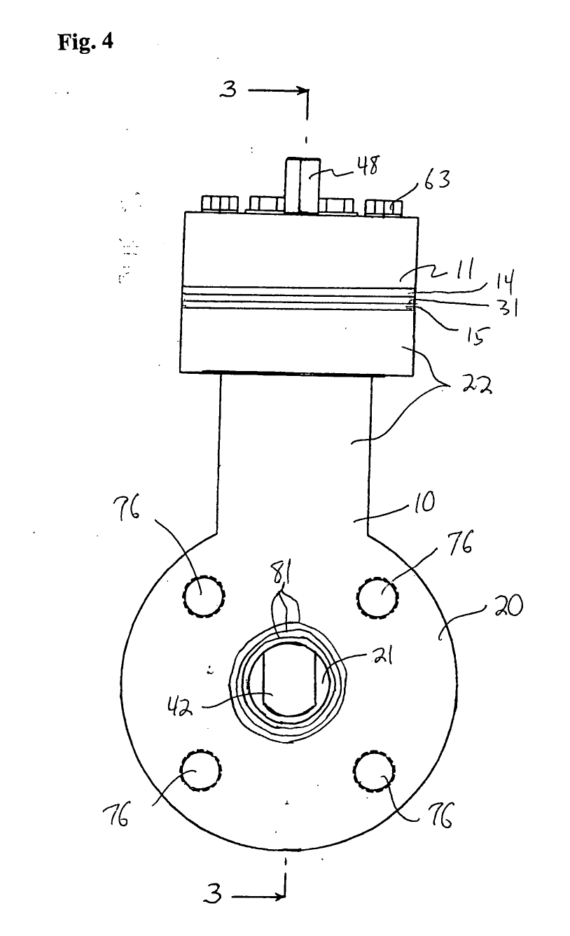

FIG. 4 is a front view of the embodiment depicted in FIG. 3, the relationship between FIGS. 3 and 4 being that the view of FIG. 3 is a section along the line 3-3 shown in FIG. 4. Referring to FIG. 4, the flow channel 21 has a circular flow channel inlet, within which a portion of the translator 42 is evident in FIG. 4. Upon rotation of the translator main shaft 40, by virtue of its threaded connection to the translator stub shaft 41 to which the translator 42 is attached, the translator 42 moves up and down from the perspective shown in FIG. 4, thereby altering the extent of interference in the flow channel 21 created by the translator 42.

FIG. 5 is a cross-sectional view along the line 5-5 in FIG. 3. As can be seen from FIG. 5, the cross-sectional shape of the translator 42 is triangular, with a flat side facing upstream and the apex on the downstream side thereof (i.e., fluid flowing through the flow channel 21 moves from left to right in FIG. 5, first reaching a flat surface, moving around the flat surface and then passing the apex on the backside of the translator 42).

Referring to FIG. 8, which shows the translator guide 60 separate from the valve, the translator guide 60 has a translator guide opening 61 guide has a triangular cross-section which is slightly larger than the cross-section of the portion of the translator 42 which engages the translator guide 60.

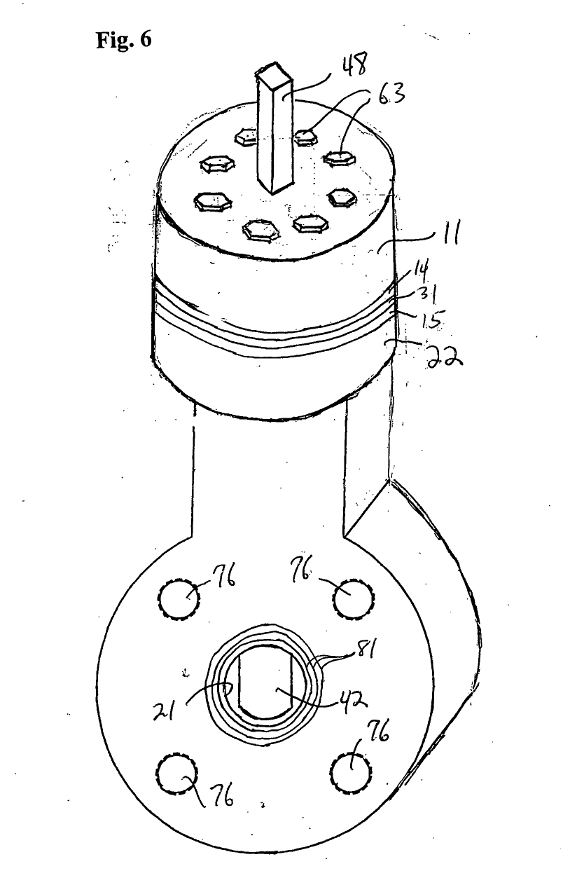

FIG. 6 is a perspective view of the valve depicted in FIGS. 3-5.

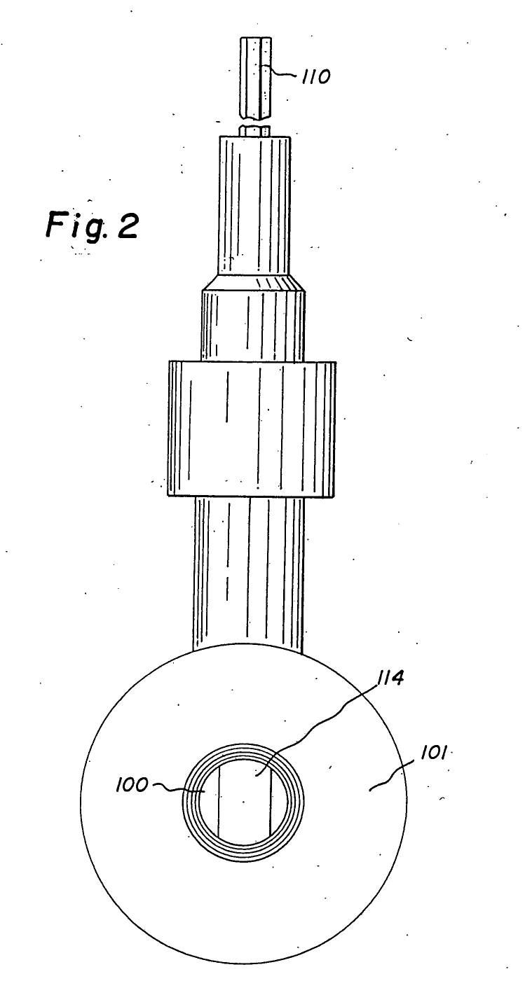

Although the embodiment of a valve depicted in FIGS. 2-6 is in a particular orientation, and directional references are made herein based on that orientation (e.g., the translator moves “up” and “down” relative to the valve body), the valve depicted in FIGS. 2-6, and in general the valves according to the present invention, can be oriented in any desired way.

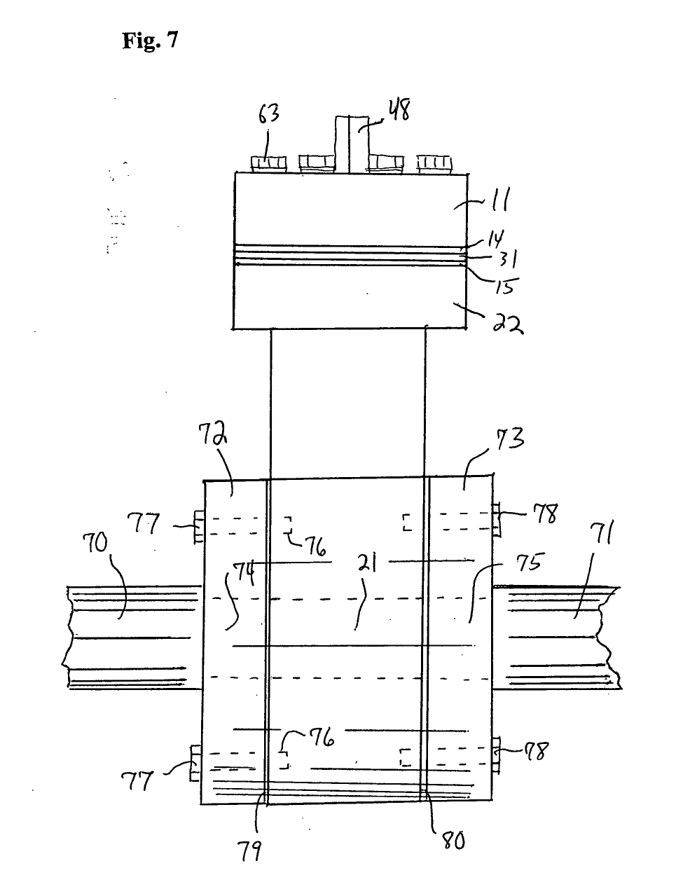

FIG. 7 depicts connection of the valve depicted in FIGS. 3-6 within a flow path between a first pipe 70 and a second pipe 71. The first pipe 70 comprises an integral first flange 72, and the second pipe 71 comprises an integral second flange 73. The first flange 72 includes a first flow path 74, and the second flange 73 includes a second flow path 75. The flow channel 21 of the valve communicates with the first pipe 70 through the first flow path 74, and with the second pipe 71 through the second flow path 75, whereby fluid passes from the first pipe 70 through the valve and into the second pipe 71.

FIG. 4 shows a set of tapped holes 76 on the front face of the valve. A similar set of tapped holes (not shown) are formed on the rear face of the valve. Referring again to FIG. 7, the valve is attached to the first flange 72 with bolts 77 which pass through bores formed in the first flange 72 and which are threaded into the tapped holes 76. Similarly, the valve is attached to the second flange 73 with bolts 78 which pass through bores formed in the second flange 73 and which are threaded into the tapped holes on the rear face of the valve.

Positioned between the first flange 72 and the valve is a first gasket 79. Positioned between the second flange 73 and the valve is a second gasket 80.

FIG. 4 shows an inlet raised face surrounding the inlet to the flow channel 21, the raised face comprising concentric grooves 81 which engage the first gasket 79. Similarly, the valve includes an outlet raised face (not shown) surrounding the outlet from the flow channel 21, which engages the second gasket 80.

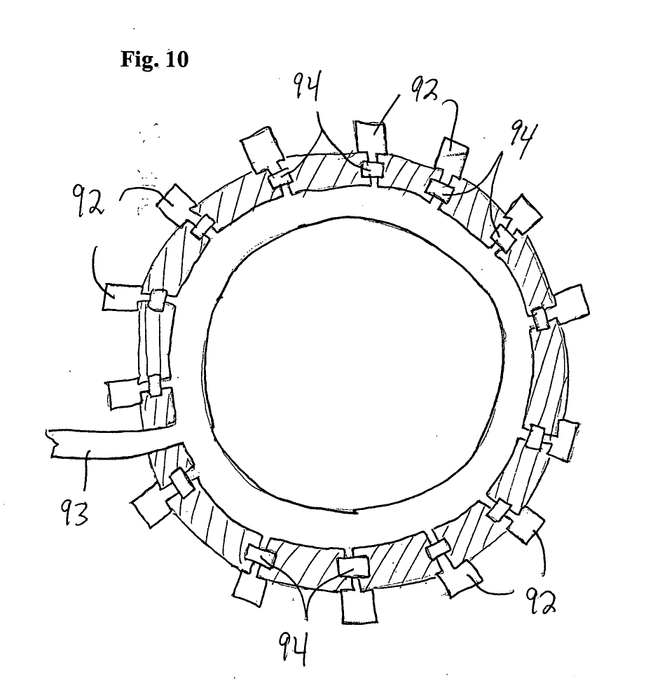

FIG. 9 is a schematic view of a power generating system which includes a turbine 91 and a plurality of combustion canisters 92. FIG. 10 is a schematic sectional view along line 10-10 in FIG. 9, and shows a combustion system which comprises a fuel supply 93, combustion canisters 92 and valves 94 according to the present invention.

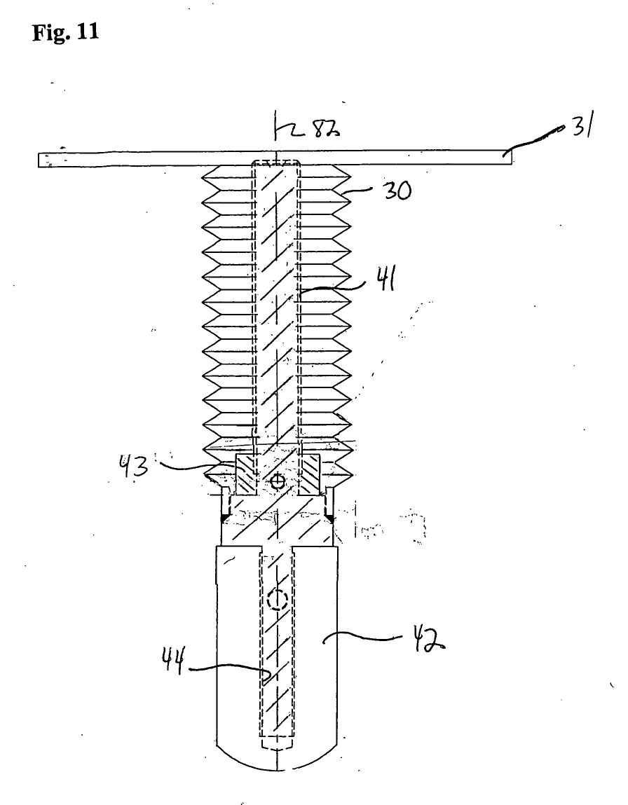

FIG. 11 is a sectional view of the bellows assembly 12, the stub shaft collar 43 and the translator 42. The bellows assembly includes the bellows flange 31 and the bellows 30. Also shown in FIG. 11 is the translator stub shaft 41, and the axis 82 of the translator assembly.

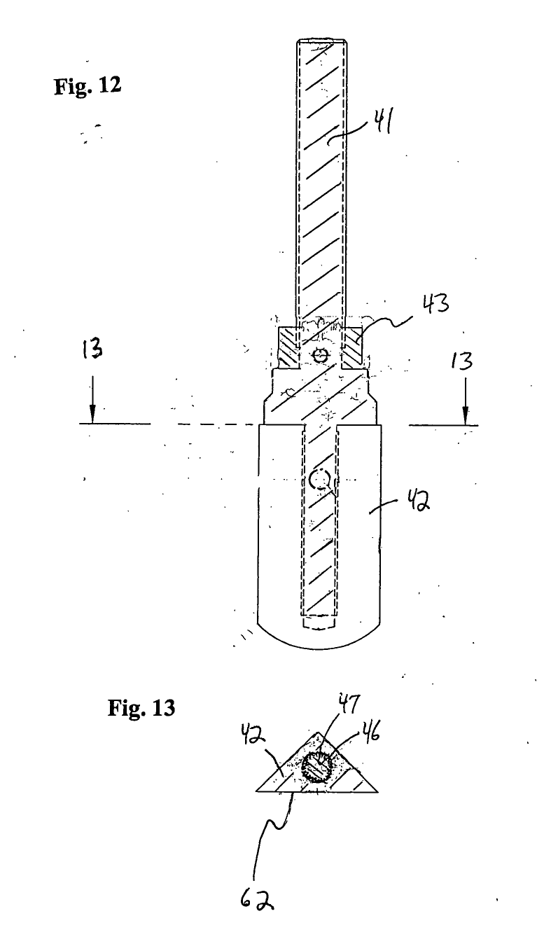

FIG. 12 is a sectional view of the stub shaft 41, the stub shaft collar 43 and the translator 42.

FIG. 13 is a sectional view along line 13-13 in FIG. 12, and shows the translator 42 and its guide-engaging portion 62, as well as the threads 46 on the translator 42 and the translator-engaging threads 47 on the translator stub shaft 41.

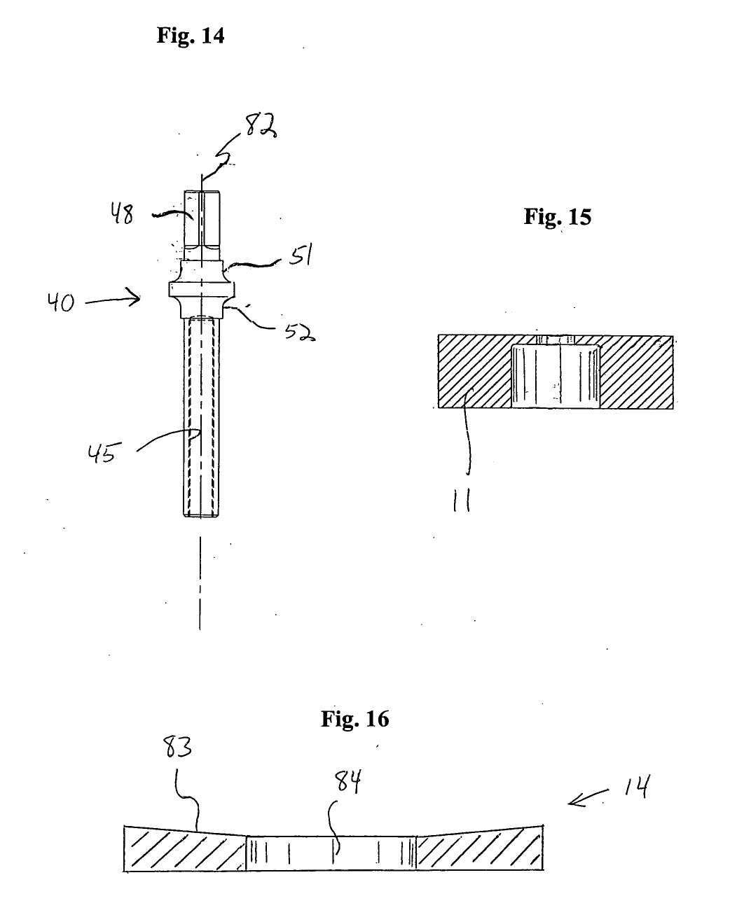

FIG. 14 is a perspective view of the translator main shaft 40, including the cranking portion 48, the first shoulder portion 51, the second shoulder portion 52, the threads 45 on the translator main shaft 40, and the axis 82 of the translator assembly.

FIG. 15 is a sectional view of the bonnet 11.

FIG. 16 is a sectional view of a bearing plate 14 which has a sloped surface 83 and a bearing plate opening defined by a wall 84. FIG. 16 is drawn not to scale in order to emphasize the slope of the sloped surface 83.

Any two or more structural parts of the valves described above can be integrated. Any structural part of the valves described above can be provided in two or more parts.

1. A valve comprising:
a valve body, said valve body comprising a flow channel defining region which defines a flow channel;
a bonnet;
a bellows assembly comprising a bellows and a bellows flange, said bellows flange being positioned between said bonnet and said valve body, said bellows flange defining a bellows flange opening, said bellows being attached to said bellows flange around said bellows flange opening; and
a translator assembly comprising a translator main shaft, a translator stub shaft and a translator, said translator assembly extending through said bellows flange opening, said bellows being attached to said translator stub shaft around a periphery of said translator stub shaft to provide a seal between said bellows flange and said translator stub shaft, said translator main shaft being threaded with said translator stub shaft, whereby rotation of said translator main shaft about an axis of said translator main shaft causes said translator to move between a first translator position and a second translator position, said translator blocking at least a portion of said flow channel when said translator is in said second translator position.

2. A valve as recited in claim 1, further comprising at least one bearing plate, said bearing plate defining a bearing plate opening through which said translator assembly extends, said bearing plate being positioned between and in contact with said bellows flange and said bonnet.

3. A valve as recited in claim 1, further comprising a first bearing means and a second bearing means, said first bearing means being in contact with a first surface of said bonnet, said second bearing means being in contact with a second surface of said bonnet, said first bearing means being spaced from said second bearing means in a direction parallel to said axis, said translator main shaft having a first shoulder portion and a second shoulder portion, said first shoulder portion abutting said first bearing means, said second shoulder portion abutting said second bearing means, whereby said translator main shaft is substantially prevented from moving along said axis relative to said bonnet or said valve body while being able to rotate freely about said axis.

4. A valve as recited in claim 1, further comprising at least one gasket positioned between and in contact with said bellows flange and said valve body, said gasket defining a gasket opening through which said translator assembly extends.

5. A valve as recited in claim 1, wherein said translator assembly further comprises a stub shaft collar.

6. A valve as recited in claim 5, wherein said stub shaft collar is attached to and non-integral with said translator stub shaft.

7. A valve as recited in claim 6, wherein said stub shaft collar is threaded on said translator stub shaft.

8. A valve as recited in claim 1, further comprising a translator guide attached to said valve body.

9. A valve as recited in claim 8, wherein said translator guide is non-integral with said valve body.

10. A valve as recited in claim 1, wherein said translator is attached to and non-integral with said translator stub shaft.

11. A valve as recited in claim 10, wherein said translator is threaded with said translator stub shaft.

12. A power generating system, comprising:
at least one turbine; and
at least one combustion system, said combustion system comprising:
at least one fuel supply;
at least one combustion canister;
at least one valve, said valve comprising:
a valve body, said valve body comprising a flow channel defining region which defines a flow channel;
a bonnet;
a bellows assembly comprising a bellows and a bellows flange, said bellows flange being positioned between said bonnet and said valve body, said bellows flange defining a bellows flange opening, said bellows being attached to said bellows flange around said bellows flange opening; and
a translator assembly comprising a translator main shaft, a translator stub shaft and a translator, said translator assembly extending through said bellows flange opening, said bellows being attached to said translator stub shaft around a periphery of said translator stub shaft to provide a seal between said bellows flange and said translator stub shaft, said translator main shaft being threaded with said translator stub shaft, whereby rotation of said translator main shaft about an axis of said translator main shaft causes said translator to move between a first translator position and a second translator position, said translator blocking at least a portion of said flow channel when said translator is in said second translator position; and
at least one fuel conduit communicating between said fuel supply and said combustion canister through said flow channel.

13. A power generating system as recited in claim 12, wherein said valve further comprises at least one bearing plate, said bearing plate defining a bearing plate opening through which said translator assembly extends, said bearing plate being positioned between and in contact with said bellows flange and said bonnet.

14. A power generating system as recited in claim 12, wherein said valve further comprises a first bearing means and a second bearing means, said first bearing means being in contact with a first surface of said bonnet, said second bearing means being in contact with a second surface of said bonnet, said first bearing means being spaced from said second bearing means in a direction parallel to said axis, said translator main shaft having a first shoulder portion and a second shoulder portion, said first shoulder portion abutting said first bearing means, said second shoulder portion abutting said second bearing means, whereby said translator main shaft is substantially prevented from moving along said axis relative to said bonnet or said valve body while being able to rotate freely about said axis.

15. A power generating system as recited in claim 12, wherein said valve further comprises at least one gasket positioned between and in contact with said bellows flange and said valve body, said gasket defining a gasket opening through which said translator assembly extends.

16. A power generating system as recited in claim 12, wherein said translator assembly further comprises a stub shaft collar.

17. A power generating system as recited in claim 12, wherein said valve further comprises a translator guide attached to said valve body.

18. A method of constructing a valve, comprising:
positioning a first bearing means in contact with a first surface of a bonnet;
positioning a translator main shaft in contact with said first bearing means, said translator main shaft having a first shoulder and a second shoulder, said contact between said first bearing means and said translator assembly being on said first shoulder;
positioning a second bearing means in contact with said second shoulder;
positioning a bearing plate in contact with said second bearing means, said bearing plate defining a bearing plate opening through which said translator main shaft extends;
positioning a bellows assembly in contact with said bearing plate, said bellows assembly comprising a bellows and a bellows flange, said bellows flange defining a bellows flange opening, said bellows being attached to said bellows flange around said bellows flange opening, said contact between said bearing plate and said bellows assembly being on said bellows flange;
threading a translator stub shaft with said translator main shaft, said translator stub shaft having a translator attached thereto;
attaching said bellows to said translator stub shaft around a periphery of said translator stub shaft to provide a seal between said bellows flange and said translator stub shaft;
positioning said translator in a translator guide attached to a valve body; and
attaching said bonnet to said valve body.

19. A method as recited in claim 18, further comprising positioning a gasket in contact with said bellows flange before said threading said translator stub shaft with said translator main shaft, said gasket defining a gasket opening through which said translator assembly extends.

20. A method as recited in claim 18, wherein said translator stub shaft further comprises a stub shaft collar.
